(19) United States
(12) Patent Application Publication
(10) Pub. No.: US 2007/0078806 A1
(43) Pub. Date: Apr. 5, 2007

(54) Method and apparatus for evaluating the accuracy of transcribed documents and other documents

(76) Inventors: Judith Ann Hinickle, Germantown, WI (US); Patrick Scott Duemling, West Bend, WI (US)

Correspondence Address: Jill Gilbert Welytok;Absolute Technology Law Group, LLC, Fourth Floor, 207 E. Michigan Ave, Milwaukee, WI, 53202, US

(21) Appl. No.: 11/529,190

(22) Filed: Sep. 28, 2006

Related U.S. Application Data
(60) Provisional application No. 60/723,887, filed on Oct. 5, 2005.

(51) Int. Cl. G06F 17/30

(52) U.S. Cl. 707/1

(57) ABSTRACT

A document evaluation system comprising: a mechanism for retrieving at least one document for review; an interface for viewing the document; a mechanism for identifying at least one error in the document; a mechanism contemporaneously creating a corrected document and a document in which the errors are marked are annotated; and a mechanism for statistically evaluating the errors.

### CROSS-REFERENCE TO RELATED APPLICATIONS

This application claims priority to U.S. Provisional patent application No. 60/723,887 filed on Oct. 5, 2005 and incorporated herein in its entirety.

### FIELD OF INVENTION

This invention relates generally to the field of transcription of documents and more specifically to a method and process for evaluating the accuracy of transcribed and other documents.

### BRIEF DESCRIPTION OF THE DRAWINGS

FIG. 1 is a flowchart of a system for contemporaneously creating: (1) a document containing error related information; and (2) a document in which errors have been corrected for a user in which no information about the errors is included.

FIG. 2 is a flowchart of a system for contemporaneously creating: (1) a document containing error related information; (2) a document in which errors have been corrected for a user in which no information about the errors is included; and (3) a report or database containing error information.

FIG. 3 shows a flowchart of a method in which errors in a document are statistically evaluated, and an error-free document is contemporaneously created.

FIG. 4 shows a flowchart of an embodiment of a method in which a reviewer or evaluator stores information about the errors and their assigned values, and may use the information to create an error report.

FIG. 5 shows a flow chart of an embodiment of a method which statistically compares errors in multiple transcripts.

FIG. 6 shows a flow chart of an embodiment a method which statistically compares errors in transcripts dictated by multiple transcriptionists.

FIG. 7 shows a flow chart of an embodiment of a method which statistically compares information about transcripts recorded using different devices.

FIG. 8 shows a flow chart of an embodiment of a method which corrects documents using a listing for identifying specific types of errors.

FIG. 9 shows an embodiment of a method in which previously reviewed documents are reviewed by a second reviewer.

FIG. 10 shows an embodiment of a method in which error messages are generated.

FIG. 11 shows a flow chart of an embodiment of a method which permits reviewers and evaluators to track time spent reviewing the transcript or document.

FIG. 12 shows an embodiment of a method by which additional information related to documents, transcriptionists, document preparation and other information is added into a database.

### BACKGROUND OF THE INVENTION

Transcriptions generally consist of a person or device listening to voice input or audio source or created by other technologies achieving the same result as voice and audio input, such as “point and click” technologies or any other technology or device known in the art, to create a document or store information in a database. Current technology requires documents containing error correction information and other references to be converted to a corrected or evaluated document in sequential steps, rather than contemporaneously created. Further, it is desirable to create reports, data bases, and other communications containing mathematical, statistical and comparative information about errors contained in transcribed documents.

The following are terms used in connection with transcription and documents:

The term “transcription” generally refers to any act in furtherance of the conversion of data or voice input to a document or database.

The term “transcriptionist” generally refers to any person or device involved in the process converting voice input to a document or database.

The term “contemporaneously” generally refers to completion of more than one project task during a time span during which a single project or task is started and completed.

The term “document” or “transcript” generally refers to any human readable format, including but not limited to a paper document, database or data transmitted using the Internet or an electronic network.

The term “voice input” generally refers to data conveyed by human vocalization or from audible mediums or processes to a recordable medium that captures or simulates human vocalization.

The term “listing” generally refers to any database or compilation of data stored in any medium.

The term “error” generally refers to a deviation from a standard.

The term “error score” generally refers to a statistical value assigned to one or more errors.

The term “device error score” generally refers to a statistical value assigned one or more errors associated with a document produced on an identified device.

The term “transcriptionist error score” generally refers to a statistical value assigned to one or more errors made by a transcriptionist in at least one document.

The term “user” generally refers to any person or device which may use, store or view a document. A user may be the same or a different person or device as the evaluator, transcriptionist or reviewer.

The term “reviewer” generally refers to any person or device (including hardware or software) which views or interprets a document for the purpose of identifying errors contained in the document or which may be created as result of at least one user relying on the document. A reviewer may be the same or a different person or device as the evaluator or user.

The term “corrects” generally refers to the process of changing data to a state which conforms to a standard identified by the reviewer.

The term “evaluate” generally means to assign a value to one or more or deviations, either individually or collectively.

The term “interface” generally refers to a display or the like for visually showing information in human readable form.

The term “corrected document” means a document in which one or more errors has been revised to conform to a standard so that the document no longer contains the errors.

The term “marked-up document” means a document in which errors have been marked, annotated or otherwise identified.

The term “marking” means annotating, visibly correcting or otherwise identifying errors or items of information in a document in which errors have been marked, annotated or otherwise identified.

The term “distributed apparatus” means an apparatus where components, elements and/or users comprising the apparatus may be located in different physical or geographical locations.

### DETAILED DESCRIPTION OF EMBODIMENTS OF THE INVENTION

For the purpose of promoting an understanding of the present invention, reference will be made to multiple embodiments of a system, method and apparatus for evaluating the accuracy of transcribed documents. It is to be understood, however, that the present invention may be embodied in various forms. For example, elements and components of a system may be presented in varying manners, and such representations are to be considered purely exemplary and representational of the elements or components which comprise the entire system, and not definitive of the order in which such components or elements perform a designated function.

Similarly, steps of a method disclosed herein may be varied in the order that they are performed. Acts and symbolically represented operations or instructions may, but are not required to, include the manipulation of electrical or biological signals by a CPU. Therefore, specific details and representations disclosed herein are not to be interpreted as limiting, but rather as a basis for the claims and as a representative basis for teaching one skilled in the art to employ the present invention. One of ordinary skill in the art will readily appreciate that modifications do not depart from the spirit and scope of the present invention, some of which are mentioned in the following description.

With particular reference to the figures, the reader should also know that like numerals in different figures refer to the same elements of the embodiments. Moreover, it should be noted that each embodiment of the invention is not depicted by the figures.

Data may be maintained on a computer readable medium including magnetic disks, optical disks, organic memory, and any other volatile (e.g., Random Access Memory (“RAM”) or non-volatile (e.g., Read-Only Memory (“ROM”) mass storage system readable by a CPU. The computer readable medium includes cooperating or interconnected computer readable media, which exist exclusively on the processing system or are distributed among multiple interconnected processing systems that may be local or remote to the processing system or may be maintained by an outside entity or source.

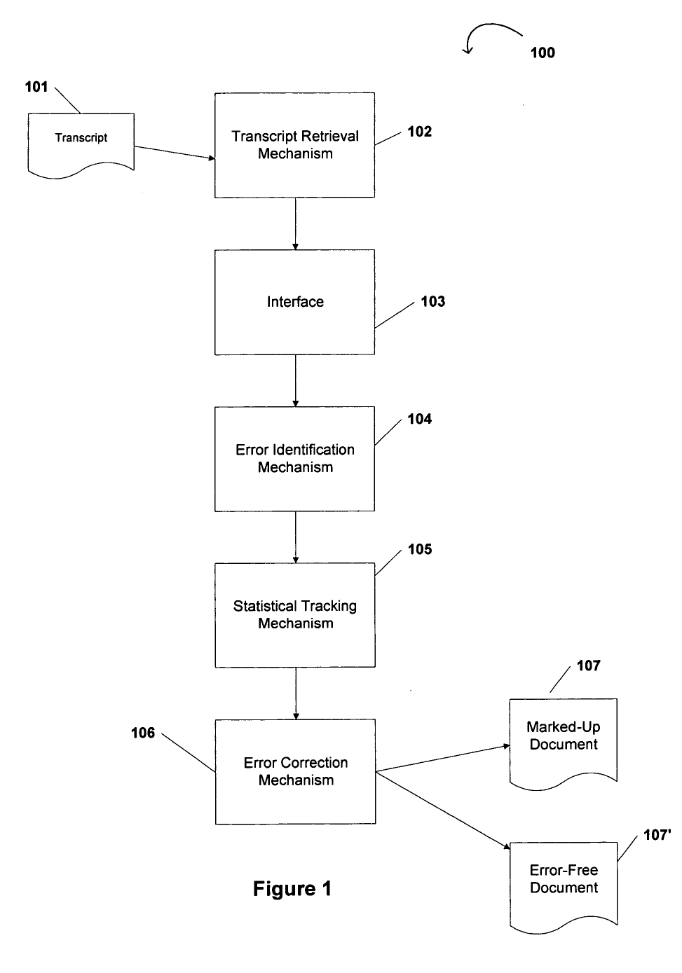

Transcript evaluation system 100 is described with reference to FIG. 1, which shows a flowchart of a system for contemporaneously creating:

(1) a document containing error related information; and (2) a document in which errors have been corrected for a user in which no information about the errors is included.

Transcript 101 is retrieved by transcript retrieval mechanism 102 and viewed on interface 103. Errors or deviations contained in transcript 101 are identified by error identification mechanism 104. Error identification mechanism 104 may be a human reviewer, software, hardware or any other mechanism known in the art, including combinations thereof. In the embodiment shown, error identification mechanism 104 is a human reviewer using hardware and software.

In the embodiment shown, statistical tracking mechanism 105 correlates or compares each error or deviation with items or deviations identified in listing 106 and statistically or mathematically evaluates the errors in transcript 101 using determined error values. However, alternative embodiments of system 100 need not include statistical tracking mechanism 105 or may include other statistical tracking mechanisms which compare or evaluate more, less or different information. Statistical tracking mechanism 105 may be a human reviewer, a hardware device, software program or any combination thereof. In the embodiment shown, statistical tracking mechanism 105 is a human reviewer using software and hardware configured to mathematically or statistically evaluate errors with respect to standard usage of language, characters and syntax within an established linguistic, professional or technical context relied upon as a standard for correctness. Errors are assigned a value based upon a listing which may be a database, model, or the knowledge and assessment of the individual reviewer.

Document correction mechanism 106 transmits information about errors, values, references or statistical information about the document and contemporaneously corrects errors to create marked-up document 107 error-free document 107′. A document correction mechanism may be a human reviewer, a hardware device, software program or any combination thereof. In the embodiment shown, document correction mechanism 106 is an individual using software and hardware configured to identify errors.

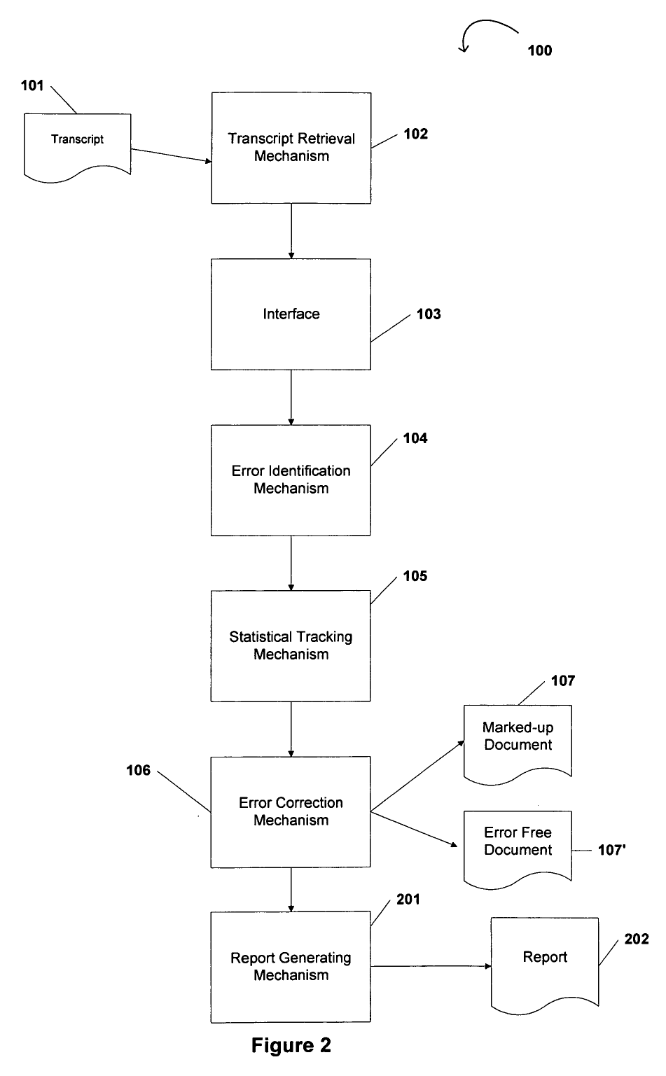

FIG. 2 is a flowchart of an additional embodiment of system 100 in which, report generating mechanism 201 creates report 202 with statistical, mathematical or comparative information about the errors and their assigned values. A report generating mechanism may be a human reviewer, a hardware device, software program or others known in the art, including combinations thereof. In the embodiment shown, report generating mechanism 201 is an individual using software and hardware configured to generate at least one report about one or more errors.

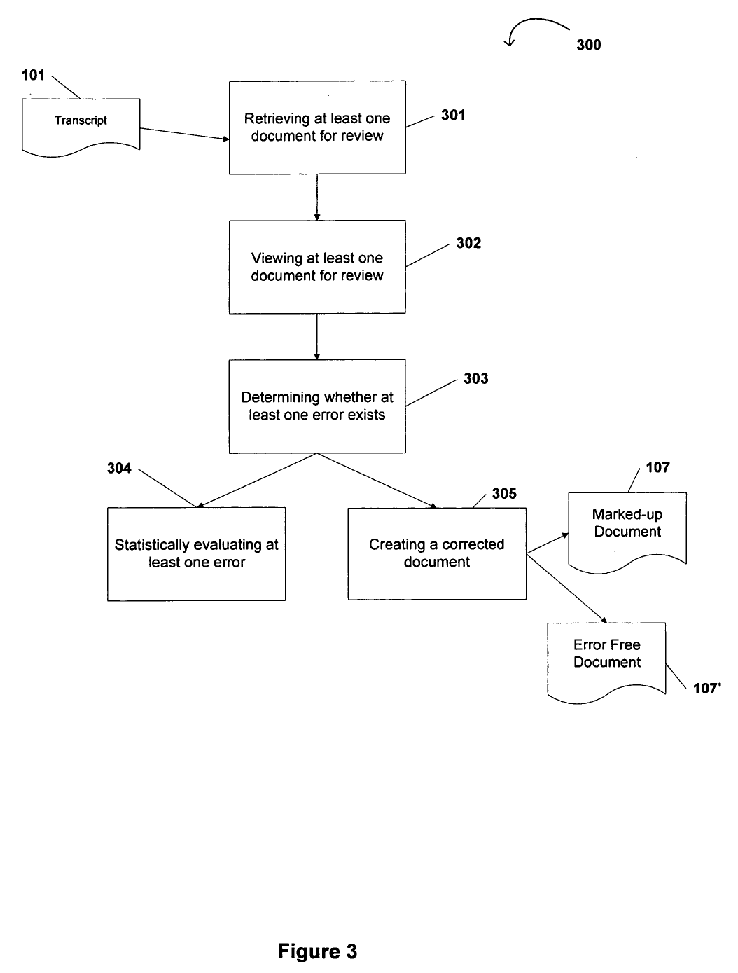

FIG. 3 shows a flow chart illustrating an embodiment of method 300 for evaluating a document. In step 301, transcript 101 is retrieved. In step 302 the transcript is viewed on an interface. In the embodiment shown, the interface is a computer interface, however, in other embodiments the interface may be a printed document, touch sensitive surface, hand-held device or any other interface capable of displaying a document.

In step 303 errors or deviations contained in the document are identified and tracked by a reviewer. A reviewer may be a human reviewer, a hardware device, software program or any combination thereof. In the embodiment shown, the reviewer is an individual using software and hardware configured to identify errors.

In step 304, errors, if found in transcript 101, are statistically or mathematically evaluated based on determined error values.

In step 305 errors are contemporaneously corrected to create marked up document 107 and an error-free document 107′.

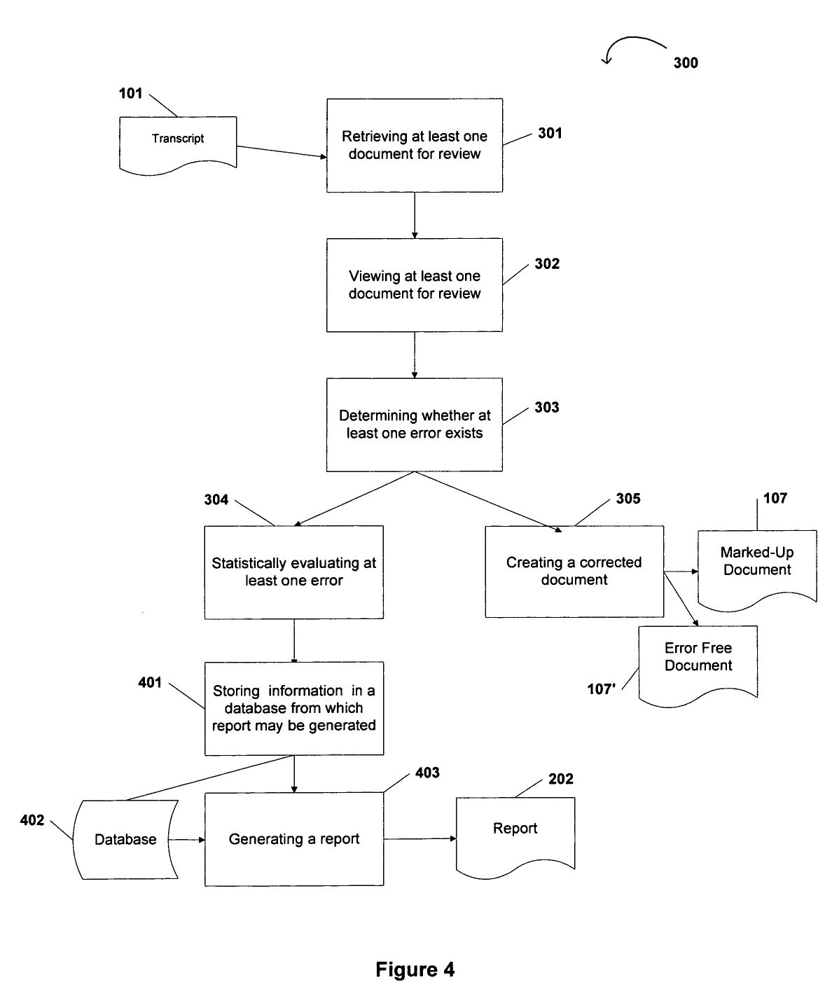

FIG. 4 shows a flow chart of one embodiment of the method which further includes step 401 of storing information in database 402 and step 403 of generating report 202. The database may be a permanent or temporary storage medium. In the embodiment shown, the database is computer hard drive or computer disk, however in other embodiments the database may be paper, a processing device or a randomly accessed memory.

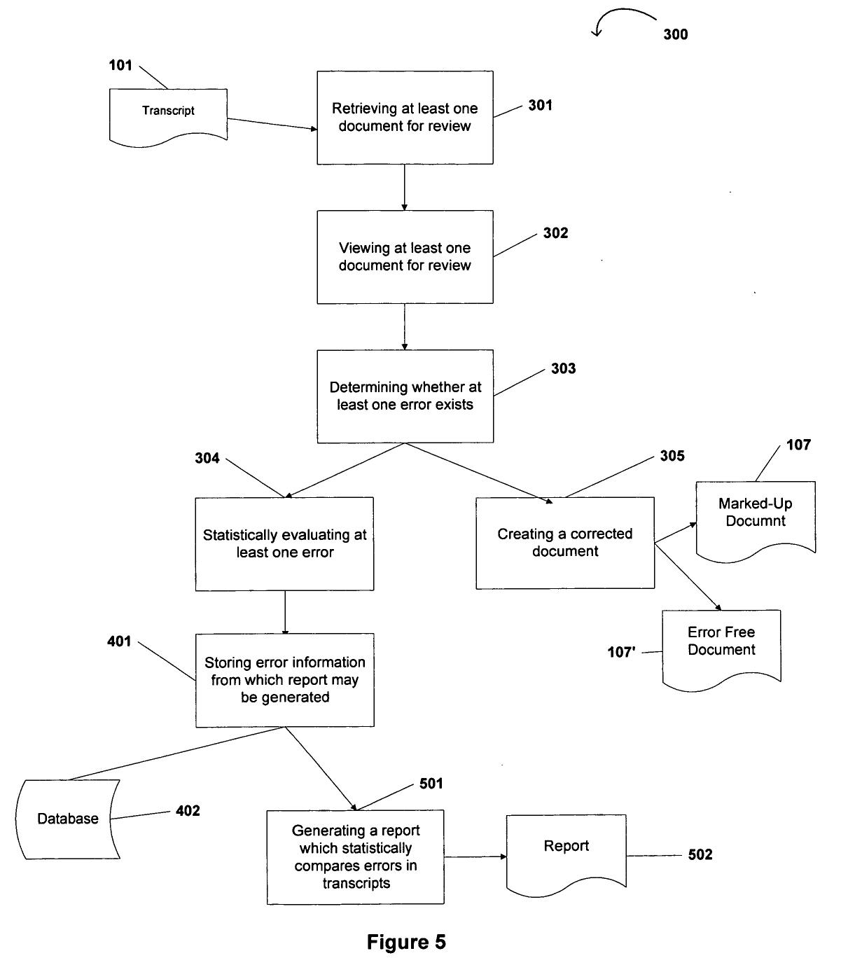

FIG. 5 shows a flow chart of one embodiment of the method which further includes the step 501 of generating report 502 which statistically compares errors made on multiple transcripts. In the embodiment shown, errors are compared on multiple transcripts prepared by the same transcriptionist and a report is generated containing information comparing statistical error information about each document. However, in other embodiments, documents compared may be prepared by multiple transcriptionists. In the embodiment shown, the report summarizes errors identified by the reviewer in the transcript or document and the values assigned to such errors. However, in other embodiments, more, less or different information may be summarized in a report. A report may be a separate communication, document, report or data entry in a database.

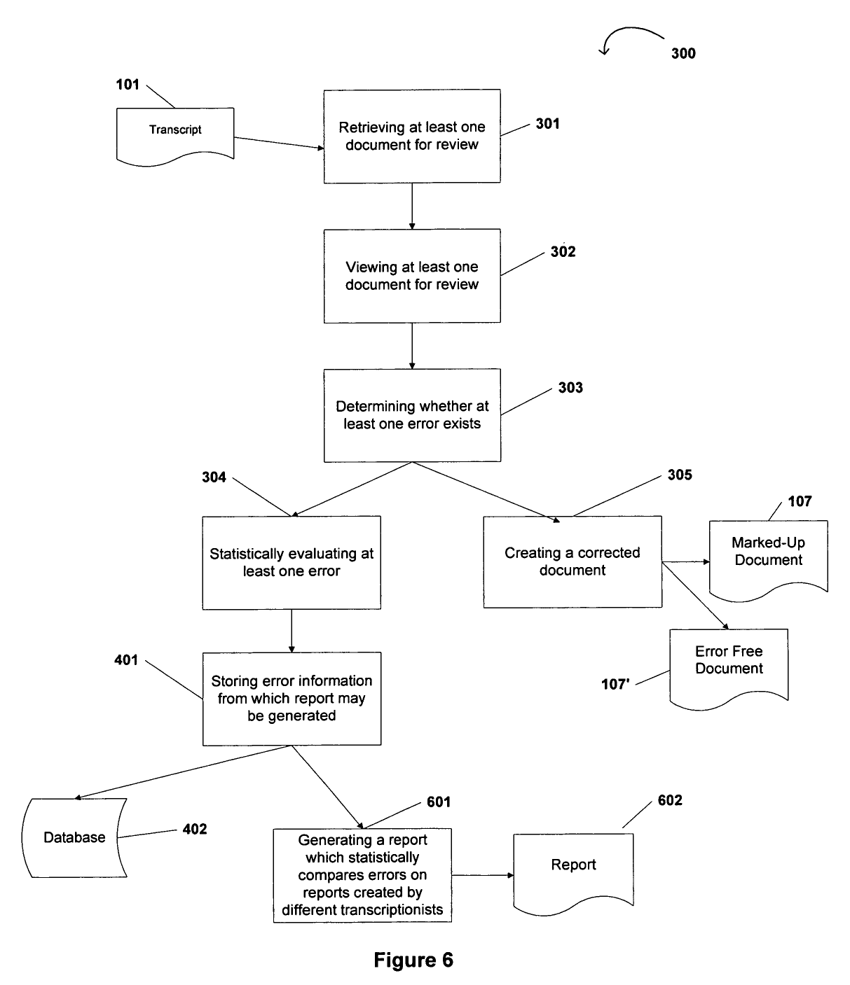

FIG. 6 shows a flow chart of one embodiment of the method which further includes the step 601 statistically comparing information about errors in transcripts dictated by different transcriptionists and generating report 602.

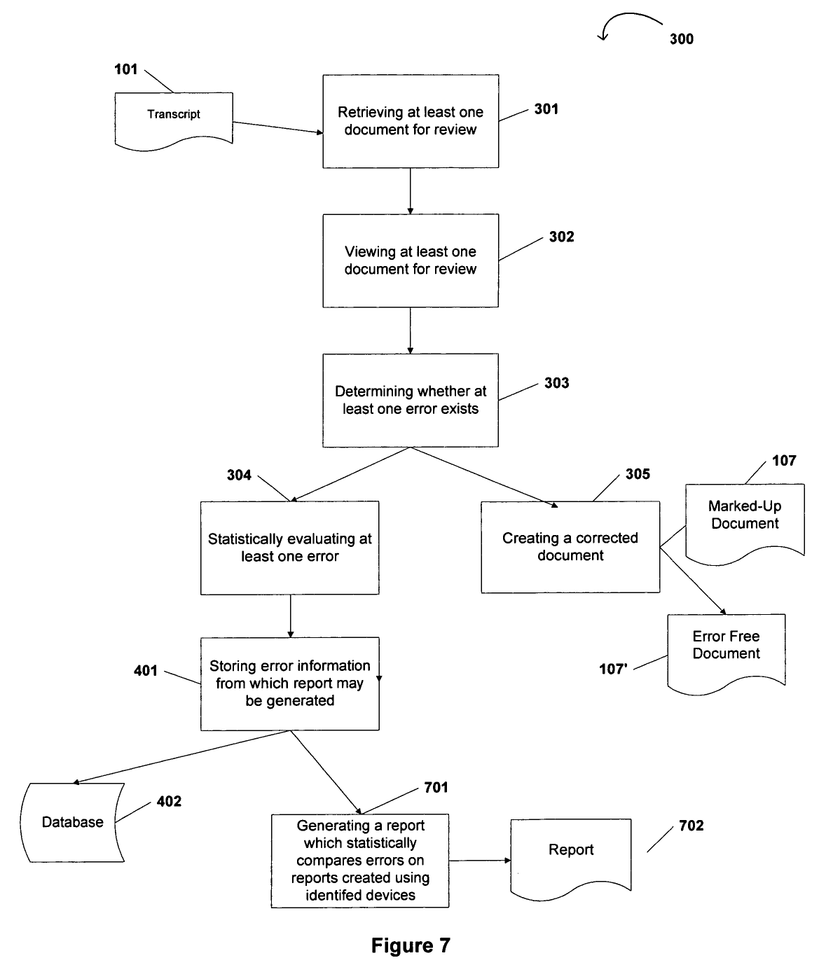

FIG. 7 shows a flow chart of one embodiment of the method which further includes the step 701 of statistically comparing information about transcripts recorded using identified devices, including but not limited to dictating equipment, telephones, visual recording devices, keyboards, touch sensitive screens, software, hardware or any other device capable of capturing data included in a document and generating a report 702.

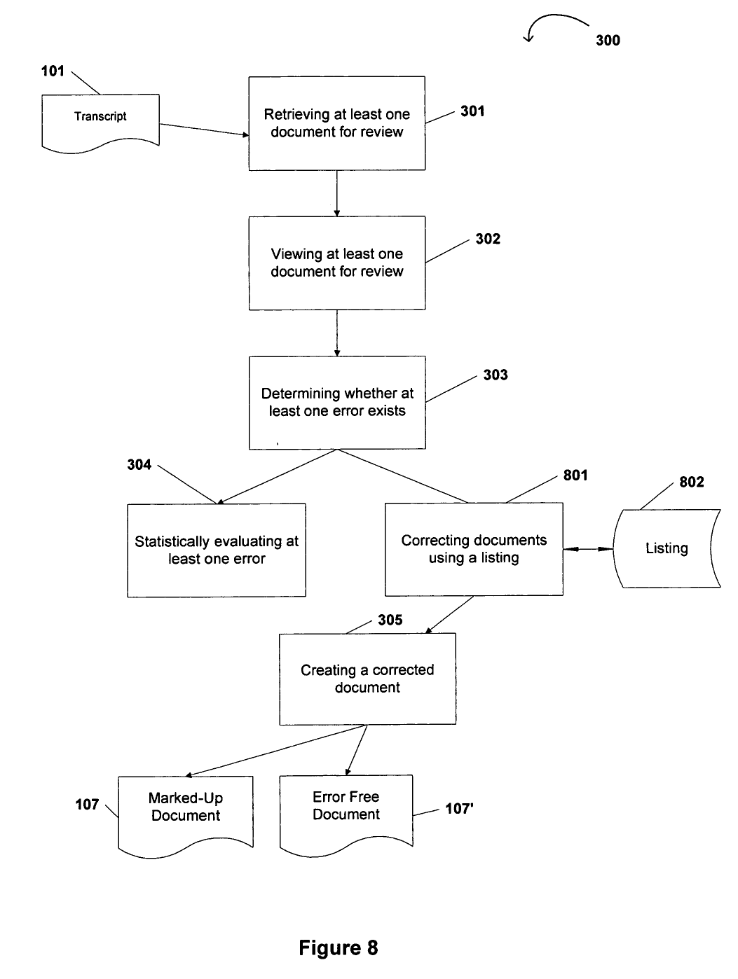

FIG. 8 shows a flow chart of one embodiment of the method which further includes step 801 of correcting documents using listing 802 for identifying specific types of errors including but not limited to medical transcription errors, accounting or legal errors, mathematical errors, procedural errors, errors in a sequence, inventory errors or discrepancies, errors in terminology, jargon or syntax unique to particular fields, grammar or stylistic errors or any other in information capable of being compared to a database for verification. Another embodiment of this invention includes a component and/or step for listing of words, concepts or numeric values to be compared to the words and numeric values used in the document so that errors may be identified by their failure to appear in this listing rather than by their presence in the listing.

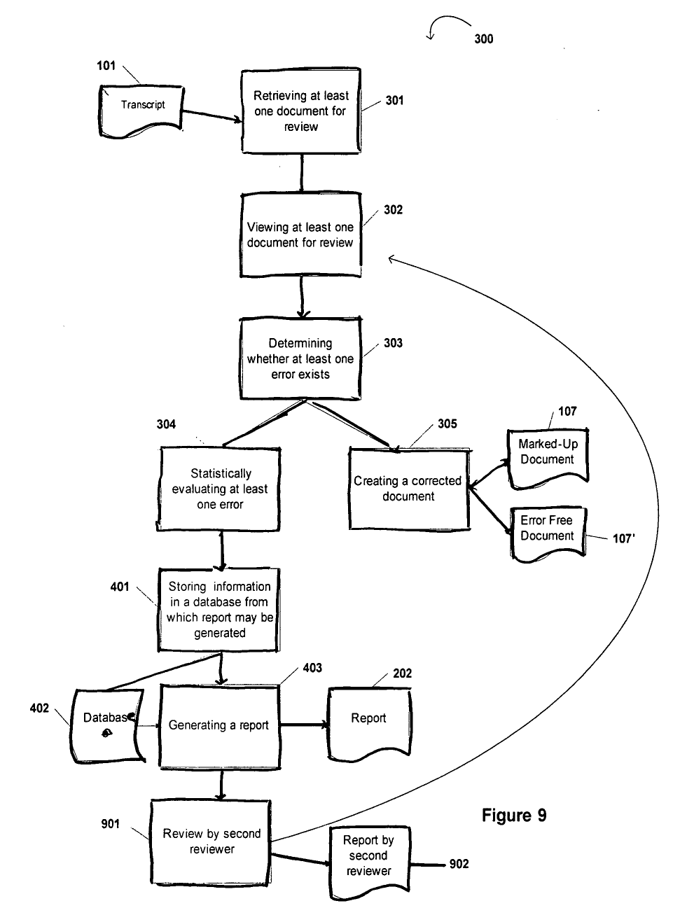

FIG. 9 shows a flow chart of one embodiment of the method which further includes step 901 in which errors may be identified by a second reviewer not identified by a previous reviewer and values are then assigned to errors. In the embodiment shown, a separate report 902 is generated by the second reviewer, but embodiments may not include a separate report.

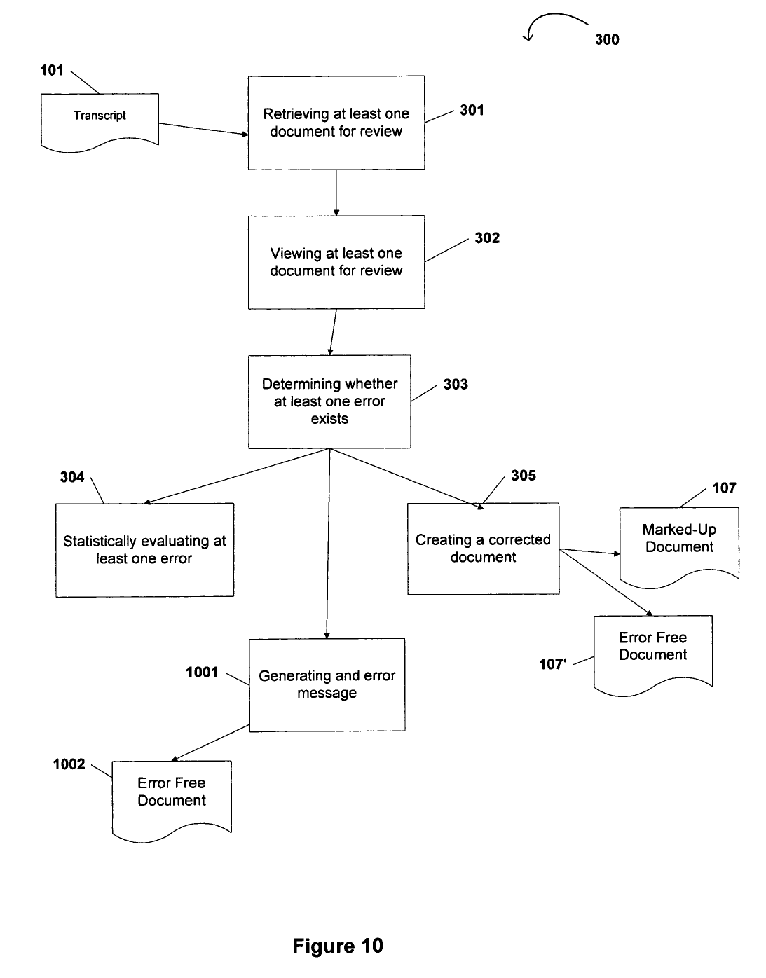

FIG. 10 shows a flow chart of one embodiment of the method which further includes step 1001 in which message 1002 is generated with information about or relating to an error that has been identified and such method is included in a document or report. In the embodiment shown, a message is generated to educate the document preparers; however, messages may be generated for any purpose and may contain any information which informs document preparers, reviewers, administrative personnel, supervisors and others related to errors and the correction of erroneous information.

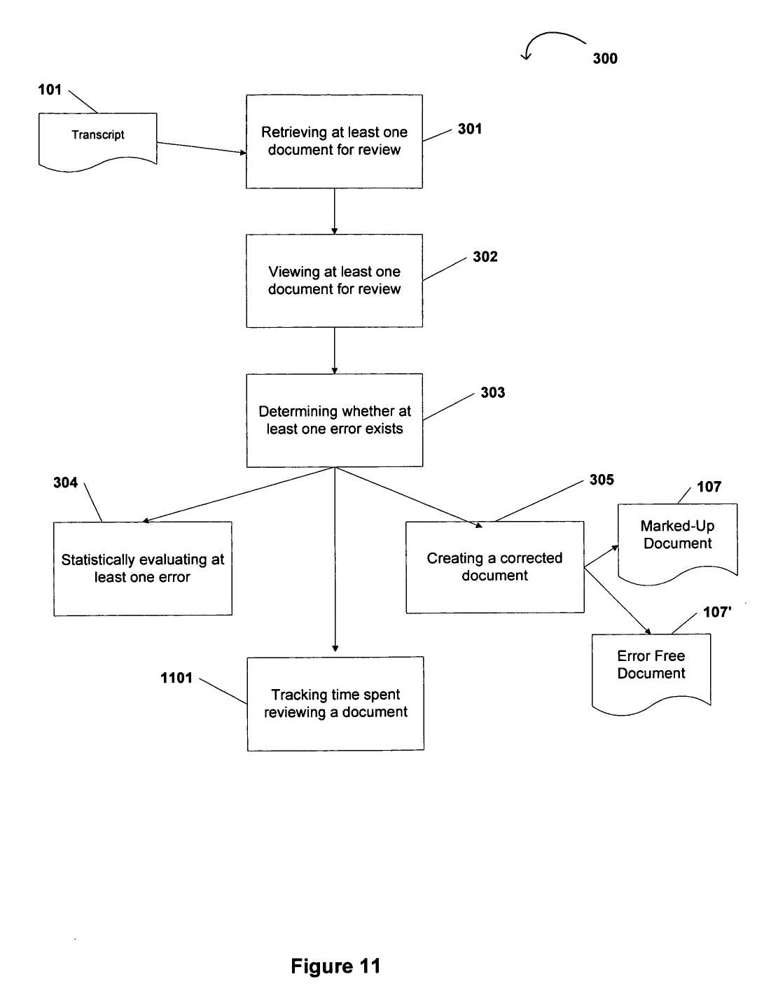

FIG. 11 shows a flow chart of one embodiment of the method which further includes step 1101 which permits reviewers and evaluators to track time spent reviewing the transcript or document.

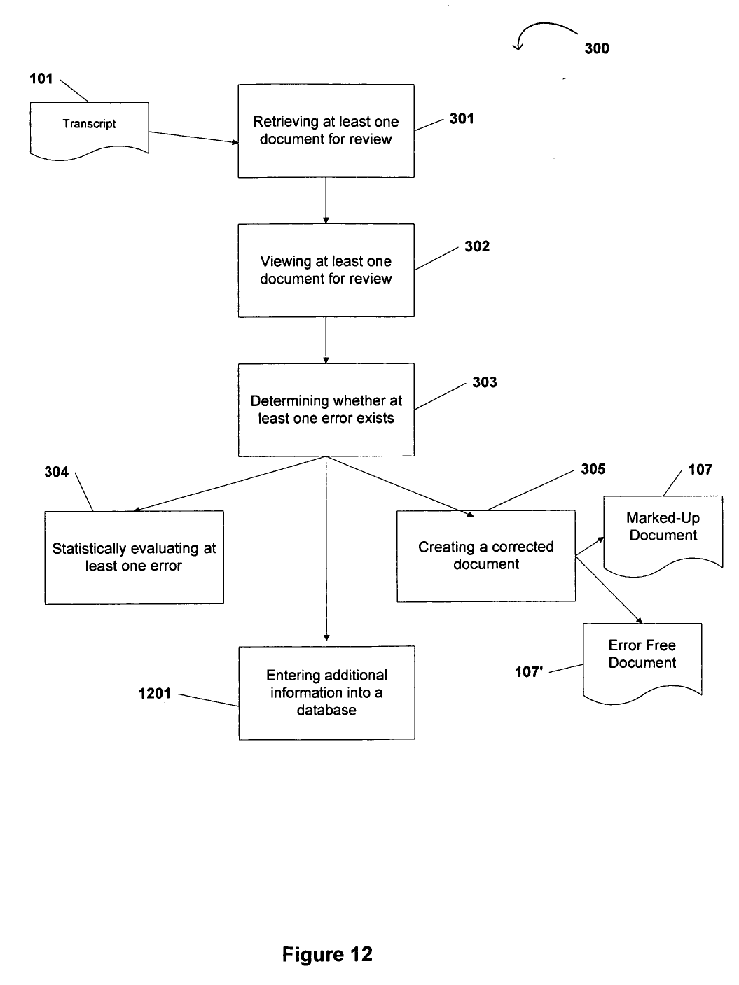

FIG. 12 shows a flow chart of one embodiment of the method which further includes step 1201 by which the following information may be entered into a database:
a. Information about document sites, editors, information relating to document identification, document type, audio file source;
b. options for tracking errors in the document;
c. error point values,
d. information about voice input and dictators
e. data pertaining to document types
f. data pertaining to transcriptionists
g. data pertaining to editors
h. data pertaining to document length
i. desired report or output media for reports
j. one or more process types to be used (e.g., Transcription, Dictation or Protocol)
k. data pertaining to the length of dictation,
l. one or more editing or error identification modes
m. one or more formats in which to save the document
n. formats for viewing and editing reports
o. information about editors, sites, document types, and document identifying information.

It should be understood that the programs, processes, methods and systems described herein are not related or limited to any particular type of computer or network system (hardware or software), unless indicated otherwise. Various types of general purpose or specialized components may be used with or perform operations in accordance with the teachings described herein.

In view of the wide variety of embodiments to which the principles of the present invention can be applied, it should be understood that the illustrated embodiments are exemplary only. The illustrated embodiments should not be taken as limiting the scope of the present invention.

For example, the steps of the method may be taken in sequences other than those described, and more or fewer elements may be used in the block diagrams. While various elements of the exemplary embodiments have been described as being implemented in software, in other embodiments hardware or firmware implementations and vice-versa may alternatively be used.

What is claimed is:

1. A document evaluation system comprising:
a mechanism for retrieving at least one document for review;
an interface for viewing said at least one document for review;
a mechanism for identifying whether at least one error in said at least one document for review exists;
a mechanism for statistically evaluating said at least one error; and
a mechanism for contemporaneously creating a corrected document and marking said at least one error identified in said at least one document for review.

2. The document evaluation system of claim 1, wherein said document evaluation system further includes a mechanism for storing information about said at least one error;

3. The document evaluation system of claim 1, wherein said document evaluation system further includes a report generating mechanism for generating a report about said at least one error.

4. The document evaluation system of claim 1, wherein said document evaluation system further includes a mechanism for comparing a first document error score to at least one additional document error score.

5. The document evaluation system of claim 1, wherein said document evaluation system further includes a mechanism for comparing a first transcriptionist error score to at least one additional transcriptionist error score.

6. The document evaluation system of claim 1, wherein said document evaluation system further includes a mechanism comparing a first device error score to at least one additional device error score.

7. The document evaluation system of claim 1, wherein said document evaluation system further includes a mechanism for generating a reviewer report which statistically compares a first reviewer error score to at least one additional reviewer error score.

8. The document evaluation system of claim 1, wherein said document evaluation system further includes a mechanism for allowing a human reviewer to manually correct said at least one document for review.

9. The document evaluation system of claim 1, wherein said document evaluation system further includes a mechanism for allowing a human reviewer to statistically evaluate said at least one document for review.

10. The document evaluation system of claim 1, wherein said document evaluation system further includes a mechanism for allowing a reviewer to compare said at least one document to a listing.

11. The document evaluation system of claim 1, wherein said document evaluation system further includes a mechanism for correcting said at least one document for review that has previously been corrected by at least one reviewer.

12. The document evaluation system of claim 1, wherein said document evaluation system further includes a mechanism for tracking reviewer time.

13. The document evaluation system of claim 1, wherein said document evaluation system further includes a mechanism for allowing said reviewer to save work when creating said corrected document and marking said at least one error identified in said at least one document for review.

14. The document evaluation system of claim 1, wherein said document evaluation system further includes a mechanism for entering additional information into an information database.

15. A method of evaluating documents comprising the steps of:
retrieving at least one document for review;
viewing said at least one document for review;
identifying whether at least one error in said at least one document for review exists;
statistically evaluating said at least one error; and
contemporaneously creating a corrected document and marking said at least one error identified in said at least one document for review.

16. The method of evaluating documents of claim 15, wherein said method further includes a step of storing information about said at least one error.

17. The method of evaluating documents of claim 15, wherein said method further includes a step of generating a report about said at least one error.

18. The method of evaluating documents of claim 15, wherein said method further includes a step of comparing a first document error score to at least one additional document error score.

19. The method of evaluating documents of claim 15, wherein said method further includes a step of comparing a first transcriptionist error score to at least one additional transcriptionist error score.

20. The method of evaluating documents of claim 15, wherein said method further includes a step of comparing a first device error score to at least one additional device error score.

21. The method of evaluating documents of claim 15, wherein said method further includes a step of generating a reviewer report which statistically compares a first reviewer error score to at least one additional reviewer error score.

22. The method of evaluating documents of claim 15, wherein said method further includes a step of a human reviewer manually correcting said at least one document for review.

23. The document evaluation system of claim 15, wherein said method further includes a step of a human reviewer statistically evaluating said at least one document for review.

24. The method of evaluating documents of claim 15, wherein said method further includes a step of allowing a reviewer to compare said at least one document to a listing.

25. The method of evaluating documents of claim 15, wherein said method further includes a step of correcting said at least one document for review that has previously been corrected by at least one reviewer.

26. The method of evaluating documents of claim 15, wherein said method further includes a step of tracking reviewer time.

27. The method of evaluating documents of claim 15, wherein said method further includes a step of allowing said reviewer to save work when creating said corrected document and marking said at least one error identified in said at least one document for review.

28. The method of evaluating documents of claim 15, wherein said document evaluation system further includes a mechanism for entering additional information into an information database.

29. A distributed apparatus for evaluating documents comprising:
a mechanism for retrieving at least one document for review;
an interface for viewing said at least one document for review;
a mechanism for determining whether at least one error in said at least one document for review exists;
a mechanism for storing information about said at least one error and contemporaneously creating a corrected document without altering said at least one document for review; and
a mechanism for statistically evaluating said at least one error.

30. The distributed apparatus for evaluating documents of claim 29, wherein said document evaluation apparatus further includes a mechanism for storing information about said at least one error.

31. The distributed apparatus for evaluating documents of claim 29, wherein said document evaluation apparatus further includes a report generating mechanism for generating a report about said at least one error.

32. The distributed apparatus for evaluating documents of claim 29, wherein said document evaluation apparatus further includes a mechanism for storing said information in a database about said at least one error.

33. The distributed apparatus for evaluating documents of claim 29, wherein said document evaluation apparatus further includes a mechanism for comparing a first document error score to at least one additional document error score.

34. The distributed apparatus for evaluating documents of claim 29, wherein said document evaluation apparatus further includes a mechanism for comparing a first transcriptionist error score to at least one additional transcriptionist error score.

35. The distributed apparatus for evaluating documents of claim 29, wherein said document evaluation apparatus further includes a mechanism comparing a first device error score to at least one additional device error score.

36. The distributed apparatus for evaluating documents of claim 29, wherein said document evaluation apparatus further includes a mechanism for generating a reviewer report which statistically compares a first reviewer error score to at least one additional reviewer error score.

37. The distributed apparatus for evaluating documents of claim 29, wherein said document evaluation apparatus further includes a mechanism for allowing a reviewer to compare said at least one document to a listing.

38. The distributed apparatus for evaluating documents of claim 29, wherein said document evaluation apparatus further includes a mechanism for correcting said at least one document for review that has previously been corrected by at least one reviewer.

39. The distributed apparatus for evaluating documents of claim 29, wherein said document evaluation apparatus further includes a mechanism for tracking reviewer time.

40. The distributed apparatus for evaluating documents of claim 29, wherein said document evaluation apparatus further includes a mechanism for allowing said reviewer to save work when creating said corrected document and marking said at least one error identified in said at least one document for review.

41. The distributed apparatus for evaluating documents of claim 29, wherein said document evaluation apparatus further includes a mechanism for entering additional information into an information database.
